(19) United States
(12) Patent Application Publication
(10) Pub. No.: US 2017/0374568 A1
(43) Pub. Date: Dec. 28, 2017

(54) ADAPTIVE NETWORK ACCESS SERVICE

(71) Applicant: Able Device, Inc., Raleigh, NC (US)

(72) Inventors: Michael C. Heath, Cary, NC (US); Roger D. Dewey, Raleigh, NC (US); Ian J. Johnson, North Bend, WA (US)

(21) Appl. No.: 15/415,103

(22) Filed: Jan. 25, 2017

Related U.S. Application Data
(60) Provisional application No. 62/355,295, filed on Jun. 27, 2016.

(51) Int. Cl. H04W 24/08; H04W 24/02; H04W 8/26; H04W 48/02; H04W 8/02

(52) U.S. Cl. CPC H04W 24/08; H04W 48/02; H04W 8/02; H04W 8/26; H04W 24/02

(57) ABSTRACT

Systems, Devices, and Methods are disclosed for modifying access list for a cellular phone operating remotely on cellular network. In some embodiments, the cellular device will send signal environment information to a server device identifying characteristic about the networks on which it is operating. The server device performs optimizations on aggregated data to determine an updated access list, which is subsequently sent to the cellular device for application. Over time, the efficacy of the aggregated data improves as additional cellular devices report signal environment information and the performance of updated access list is quantified. In some embodiments, the access list is wrapped in an access policy, which may include application rules enabling to cellular device to determine, based on context, at time at which the updated access list should be applied. In some embodiments, the cellular device sends notification to the server device when an updated access list is applied.

### CROSS REFERENCE TO RELATED APPLICATION

This application claims the benefit of U.S. Provisional Application 62/355,295 filed on Jun. 27, 2016, the disclosure of which is incorporated herein by reference in their entirety.

### TECHNICAL FIELD

The present disclosure relates to increasing network availability in cellular radio equipped devices.

### BACKGROUND

The primary purpose of the system described herein is to provide for optimizations in the cellular device's network access process. This is done by making changes in the authorized network registration listing (access list) of the cellular device. These changes enable optimizations in connectivity of the cellular device through enabling access to different cellular networks in the area it which it is operating in. Presently, cellular devices and phones have a network access list which allows the device to request access to the available channels in an area of operation. These lists are usually prioritized as preferred, roaming, or forbidden. Thus, the available networks the device is allowed to access are preset at the time of provisioning and not changeable remotely. This system described herein allows for changes in the network access lists in order to optimize connectivity for the device.

### SUMMARY OF THE DISCLOSURE

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

According to one general aspect of the present disclosure a system is provided. The system includes a server device and a server device operable to communicate over a cellular network. The server device includes a first network interface operable to communicate over a network; a first processor and a first memory coupled to the first network interface and operable to receive, from a cellular device, network signal environment information; determine, based on the network signal environment information, one or more updated access policies; send, to the cellular device, the one or more updated access policies.

The cellular device includes a second network interface operable to communicate over the network; a second processor and a second memory coupled to the second network interface and operable to: collect network signal environment information; send the network signal environment information to the server device; receive, from the server device, the one or more updated access policies; and apply one of the one or more updated access policies.

According to one general aspect of the present disclosure the network signal environment information includes signal strength information for one or more networks available to the cellular device, geographic location information for the one or more networks available to the cellular device, current cell site information for the one or more networks available to the cellular device, neighboring cell site information for the one or more networks available to the cellular device, and network utilization information for one or more networks available to the cellular device, unavailable networks information identifying one or more networks previously available to the cellular device having been determined to be unavailable to the cellular device, and newly available networks information identifying one or more networks previously unavailable to the cellular device having been determined to be available to the cellular device.

According to one general aspect of the present disclosure the one of the one or more updated access policies include one or more of: a preferred policy, roaming policy, and a forbidden policy.

According to one general aspect of the present disclosure the server device further operable to store the network signal environment information.

According to one general aspect of the present disclosure the server device is operable to store the network signal environment information by unique identifier.

According to one general aspect of the present disclosure the unique identifier is one or more of a IMEI and a MEID.

According to one general aspect of the present disclosure the server device is operable to receive, from a second cellular device, second network signal environment information; determine, based on the second network signal environment information, a second updated access policy; and send, to the second cellular device, the second updated access policy. A second cellular device is operable to collect second network signal environment information; send the second network signal environment information to the server device; receive, from the server device, the second updated access policy; and apply the second updated access policy.

According to one general aspect of the present disclosure determining an updated access policy includes determining, based on the network signal environment information and second network signal environment information, the updated access policy

According to one general aspect of the present disclosure the system further includes the server device further operable to: receive, from the cellular device, a unique identifier uniquely identifying the cellular device; and the cellular device further operable to store the network signal environment information by unique identifier.

According to one general aspect of the present disclosure the server device is operable to determine, based on the network signal environment information, a plurality of updated access policy; and the cellular device further operable to receive, from the server device, the plurality of updated access policy.

According to one general aspect of the present disclosure the cellular device further operable to: determine current operating conditions; designate, based on the current operating conditions, another of the one or more updated access policies; and apply the other of the one or more updated access policies.

According to one general aspect of the present disclosure the server device includes the cellular device operable to send, at a time designated by the cellular device, the network signal environment information to the server device.

According to one general aspect of the present disclosure the server device further operable to send, at a time designated by the server device, a request for the network signal environment information; and the cellular device further operable to receive, from the server device, a request for the network signal environment information; and send, based on the request, the network signal environment information to the server device.

According to one general aspect of the present disclosure the one of the one or more updated access policies comprises two or more access lists.

According to one general aspect of the present disclosure the one or more access lists include a preferred list, a roaming list, and a forbidden list configured to instruct the cellular device to communicate over a first network specified in the preferred list, when the first network is available; communicate, over a second network specified in the roaming list, when the first network is unavailable; and restrict communication, over a third network specified in the forbidden list.

According to one general aspect of the present disclosure each of the one of the one or more updated access policies comprises application rules configured to instruct the cellular device to monitor a current context of the cellular device; and for each of the one or more updated access policies perform an evaluation, based on the application rules and the current context, of an applicability score of the one or more updated access policies.

According to one general aspect of the present disclosure the cellular device is further operable to, based on the evaluation, designate a new updated access policy; and apply the new updated access policy.

According to one general aspect of the present disclosure one or more application rules are chosen from the group consisting of: a rule indicating that an updated access policy to be applied when a cellular network signal exceeds a certain threshold, a rule indicating that an updated access policy to be applied when a cellular network signal falls below a certain threshold, a rule indicating that an updated access policy to be applied when network throughput degrades by a certain percentage, a rule indicating that an updated access policy to be applied when network latency degrades by a certain percentage, a rule indicating that an updated access policy to be applied when network drops occur with a greater frequency over a certain time period, a rule indicating that an updated access policy to be applied when a geographic location changes by a certain amount, a rule indicating that an updated access policy to be applied when a certain amount of time elapses, a rule indicating that an updated access policy to be applied when a battery level of the device exceeds a certain level, a rule indicating that an updated access policy to be applied when a battery level of the device falls below a certain level, a rule indicating that an updated access policy to be applied when an amount of data being transferred by the device over a certain time period exceeds a threshold amount, a rule indicating that an updated access policy to be applied when an amount of data being transferred by the device over a certain time period falls below a threshold amount, a rule indicating that an updated access policy to be applied upon receipt, a rule indicating that an updated access policy to be applied at a certain date or time, a rule indicating that an updated access policy to be applied at a certain elevation, a rule indicating that an updated access policy to be applied under certain weather conditions, a rule indicating that an updated access policy to be applied when it is determined that the cellular device has entered a physical structure such as a building, a rule indicating that an updated access policy to be applied when it is determined that the cellular device consumed a certain amount of data on a network, a rule indicating that a user to be prompted for confirmation before applying an updated access policy, a rule indicating that a user to be notified of an updated access policy application, a rule indicating that the server device be notified upon the application of an updated access policy application, and a rule identifying one or more adjustments to be applied to the one or more application rules based on an emergency mode applied at a cellular device.

According to one general aspect of the present disclosure the cellular device further operable to send, to the server device, a notification identifying the new updated access policy.

While the present disclosure has been summarized in terms and language describing a system, it will be recognized that methods, devices, and non-transitory computer readable medium embodiments are disclosed herein and include features similar to those described above.

### BRIEF DESCRIPTION OF THE DRAWING FIGURES

The accompanying drawing figures incorporated in and forming a part of this specification illustrate several aspects of the disclosure, and together with the description serve to explain the principles of the disclosure.

FIG. 1A illustrates a block diagram of the system according to an exemplary embodiment;

FIG. 1B illustrates a block diagram of the access policy structure system according to an exemplary embodiment;

FIG. 1C illustrates a block diagram of the signal environment structure according to an exemplary embodiment;

FIG. 2A illustrates a network diagram of the system according to one aspect of the disclosure;

FIG. 2B illustrates a second network diagram of the system according to another aspect of the disclosure;

FIG. 2C illustrates a third network diagram of the system according to another aspect of the disclosure;

FIG. 3 illustrates hardware element of the cellular device according to an exemplary embodiment; and

FIG. 4 illustrates hardware element of the server device according to an exemplary embodiment.

### DETAILED DESCRIPTION

The present disclosure is described with specificity to meet statutory requirements. However, the description itself is not intended to limit the scope of this patent. Rather, the inventors have contemplated that the claimed subject matter might also be embodied in other ways, to include different steps or elements similar to the ones described in this document, in conjunction with other present or future technologies. Moreover, although the term “step” may be used herein to connote different aspects of methods employed, the term should not be interpreted as implying any particular order among or between various steps herein disclosed unless and except when the order of individual steps is explicitly described.

The network access list is presently used for all cellular networks worldwide. A problem occurs when changes occur in the networks the device is allowed to access, the cellular devices already deployed in the field have no way to change the network access list and thereby cannot take advantage of network changes and optimizations. These changes can originate from many causes; examples include additional agreements between networks occur to allow other network devices to share their resources; emergency devices being allowed to access once forbidden networks; emergency crisis occurring where additional connectivity is needed; traffic levels overwhelming a cell network; load sharing changes being required to maintain service in congested areas, and environmental conditions such as increased radio noise, weaker signal, interference degrading service.

In the systems presently deployed, it is not possible to make changes to the network access list for devices in the field. It is a goal of this disclosure to enable the updating of network access list for devices deployed in the field to allow them to take advantage of changes in network availability and to enable optimizations in server to client interactions to deployed devices.

In some embodiments of the present disclosure, the cellular device sends current signal environment information (signal strength, location info, cell site used, neighboring cells, preferred and allowed roaming lists, etc.) to a server enabling the analysis of the signal environment the device is operating in. When the signal environment information is received the server can analyze the operating environment information and, if needed, make changes in the cellular device's preferred or roaming network lists in order for the cellular device to obtain more effective network utilization and/or improved call service. This new access policy can then be updated to the cellular device from the server. This way the access policy can be optimized in the field for already deployed devices if needed. The information can also be used to acquire network utilization statistics so the server can later make changes as conditions and agreements are studied for access optimizations.

The signal environment information may be transferred to the server from the cellular device using a number of different approaches. These approaches include sending signal environment information by a server to the cellular device in response to a ‘network survey request’, sending the signal environment information autonomously by the cellular device periodically to the server as determined by a program controlling the cellular device, sending the signal environment information to the server if the cellular device's programming determines that it would be useful to report this information to the server so as to improve its network performance or to relay information back to the server for statistics, manually initiating the sending of the signal environment information based on inputs received by a human user if allowed by the device and network.

The server may react to the above received ‘network survey’ information to direct the cellular device to change its access policy or network service list (preferred, roaming, forbidden, etc.) in order to optimize the network utilization. Furthermore, the remote ‘network survey’ information can also include back off timer settings, call retry limits, etc. when access control is supported to allow the network server to also control the network access retry policy to relieve congestion if determined to be effective by the server.

Another implementation of the present disclosure is to have the cellular device act on Its own without the use of server information or server initiation. For this case the cellular device would perform the necessary network survey and determine optimizations needed to achieve better connectivity. The logic used by the internal program may utilize many factors in the network survey such as the cell site stats (signal strength, location info, cell site used, neighboring cells, preferred and allowed roaming lists, etc.) and possibly the emergency mode the device was operating in such that the network access policy could autonomously be adjusted by the cellular device without the use of a server.

Implementation of the system described herein is enabled by using the Proactive SIM program environment using the previously described SIMbae (SIM based application environment).

A SIM (Subscriber Identity Module) is a modular electronic circuit that acts as a unique ID for a cellular device so that the device can connect to, and make calls over, and be charged for using a particular cellular network. A SIM has its own processor, memory, and IO separate and aside from the cellular device into which it is slotted. As such, the SIM is able to execute programs independently from the cellular device on which it resides.

The SIMbae program is ideally suited for this system since the program is resident on the SIM and does not require input from the user or processor controlling the cell module or the phone. It also is independent of the device cellular module manufacturer. Therefore, the SIM program described in U.S. Pat. No. 8,180,402, now termed SIMbae, is ideally suited for directing and reporting of the signal environment information. Without this availability of the SIMbae system the system described herein is not known to be possible. U.S. Pat. No. 8,180,402, filed on Mar. 14, 2011 and issued on May 15, 2012, is commonly owned and is hereby incorporated by reference in its entirety to this document.

The SIM implementation for the network access optimization described herein is economical since no user or network supervision is necessary. Presently the network access profiles are hard coded in the SIM or cellular module by the network at the time of provisioning and not alterable without re-provisioning the SIM or cellular module, therefore having the SIM contain a program that can make changes to the network access profile is a cost savings over having to manually change SIMs in the field deployed devices or manually evoke a re-provisioning. The changes needed can be made using network survey information based on the conditions the units is operating in and make the changes necessary individually to each unit as the network access environment changes or as the network is optimized.

Several techniques are possible to send and receive the signal environment information and other communications between the server device and the cellular device. These techniques include using a network SMS messaging service, a network SMS proactive SIM messaging service, and a cellular internet access services such as GPRS, 1×RTT, EVDO, HSDPA, LTE or similar IP service. These data services already exist in the cellular network therefore available for utilization in the system described herein. Only the SIM resident program and a network server with optimization programs are required to seamlessly provide the network access priority service.

As referred to herein, the term “cellular device” should be broadly construed. It can include any type of computing device, for example, a smart phone, a cell phone, a pager, a personal digital assistant (PDA, e.g., with GPRS NIC), a mobile computer with a cellular radio, an IoT device, or the like. A typical computing device is a wireless data access-enabled device (e.g., an iPHONE® smart phone, a BLACKBERRY® smart phone, a NEXUS ONE™ smart phone, an iPAD™ device, or the like) that is capable of sending and receiving data in a wireless manner using protocols like the Internet Protocol, or IP, and the wireless application protocol, or WAP. This allows users to access information via wireless devices, such as smart phones, mobile phones, pagers, two-way radios, communicators, and the like. Wireless data access is supported by many wireless networks, including, but not limited to, CDPD, CDMA, GSM, PDC, PHS, TDMA, FLEX, ReFLEX, iDEN, TETRA, DECT, DataTAC, Mobitex, EDGE and other 2G, 3G, 4G and LTE technologies, and it operates with many handheld device operating systems, such as PalmOS, EPOC, Windows CE, FLEXOS, OS/9, JavaOS, Tizen, iOS and Android. Typically, these devices use graphical displays and can access the Internet (or other communications network) on so-called mini- or micro-browsers, which are web browsers with small file sizes that can accommodate the constrained operating environment of wireless devices on wireless networks. In a representative embodiment, the computing device is a cellular telephone or smart phone that operates over GPRS (General Packet Radio Services), which is a data technology for GSM networks. In addition to a conventional voice communication, a given computing device can communicate with another such device via many different types of message transfer techniques, including SMS (short message service), enhanced SMS (EMS), multi-media message (MMS), email WAP, paging, or other known or later-developed wireless data formats. Although many of the examples provided herein are implemented on a computing device, the examples may similarly be implemented on any suitable “cellular device”.

As described above, cellular device may be an IoT device. In this case, a cellular radio device may be embedded into any number of special purpose IoT devices. Examples of IoT devices may include medical monitoring equipment (heart rate monitor), exercise/activity monitoring equipment (FitBit), devices to detect and control environmental (thermostats), wearable electronics (watches), motor vehicles (Tesla), and the like. In some instances, an IoT device may be a stationary device, such as a connected thermostat. In some instances, an IoT device may be a movable device, such as a motor vehicle.

Throughout this specification, like reference numbers signify the same elements throughout the description of the figures.

When elements are referred to as being “connected” or “coupled”, the elements can be directly connected or coupled together or one or more intervening elements may also be present. In contrast, when elements are referred to as being “directly connected” or “directly coupled,” there are no intervening elements present.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be for example, but not limited to, an electronic, magnetic, optical, electromagnetic, infrared, or semiconductor system, apparatus, device, or propagation medium. By way of example, and not limitation, computer- readable media may comprise computer storage media and communication media.

Computer storage media is non-transitory and includes volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage components, or any other medium which can be used to store the desired information and may be accessed by an instruction execution system. Note that the computer-usable or computer-readable medium can be paper or other suitable medium upon which the program is printed, as the program can be electronically captured via, for instance, optical scanning of the paper or other suitable medium, then compiled, interpreted, of otherwise processed in a suitable manner, if necessary, and then stored in a computer memory.

Communication media typically embodies computer-readable instructions, data structures, program modules or other data in a modulated data signal such as a carrier wave or other transport mechanism and includes any information delivery media. The term “modulated data signal” can be defined as a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above-mentioned should also be included within the scope of computer-readable media.

When the subject matter is embodied in the general context of computer-executable instructions, the embodiment may comprise program modules, executed by one or more systems, computers, or other devices. Generally, program modules include routines, programs, objects, components, data structures, and the like, that perform particular tasks or implement particular abstract data types. Typically, the functionality of the program modules may be combined or distributed as desired in various embodiments.

Recitation of ranges of values herein are merely intended to serve as a shorthand method of referring individually to each separate value falling within the range, unless otherwise indicated herein, and each separate value is incorporated into the specification as if it were individually recited herein. Therefore, any given numerical range shall include whole and fractions of numbers within the range. For example, the range “1 to 10” shall be interpreted to specifically include whole numbers between 1 and 10 (e.g., 1, 2, 3, . . . 9) and non-whole numbers (e.g., 1.1, 1.2, . . . 1.9).

Although process (or method) steps may be described or claimed in a sequential order, such processes may be configured to work in different orders. In other words, any sequence or order of steps that may be explicitly described or claimed does not necessarily indicate a requirement that the steps be performed in that order unless specifically indicated. Further, some steps may be performed simultaneously despite being described or implied as occurring non-simultaneously (e.g., because one step is described after the other step) unless specifically indicated. Where a process is described in an embodiment the process may operate without any user intervention.

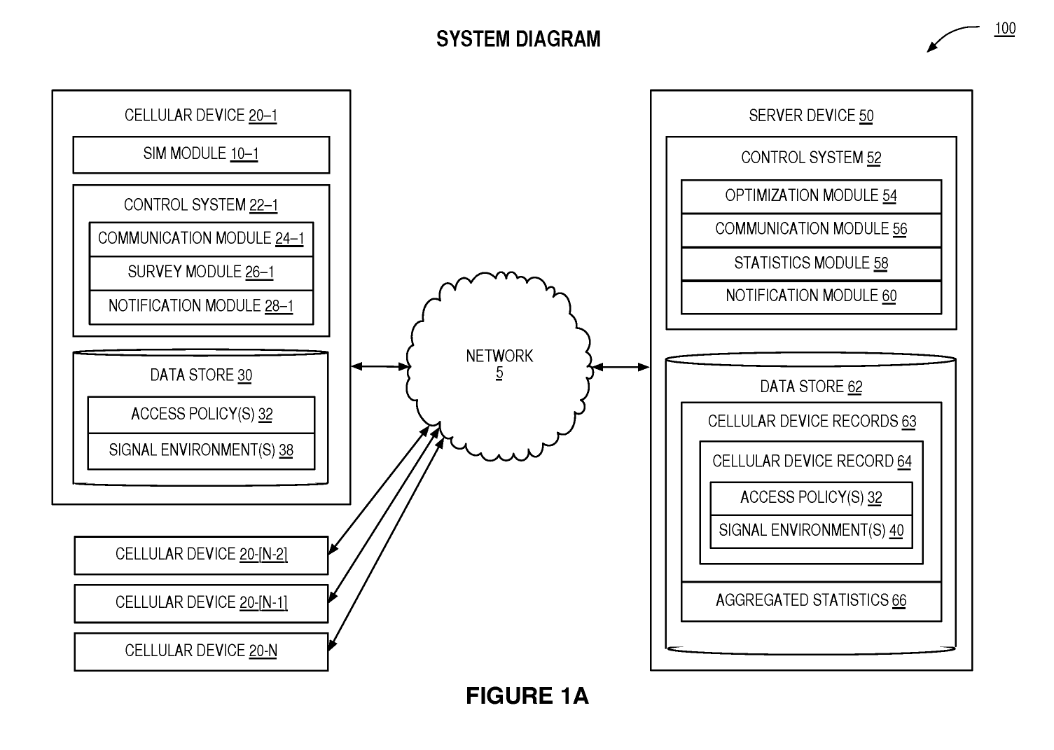

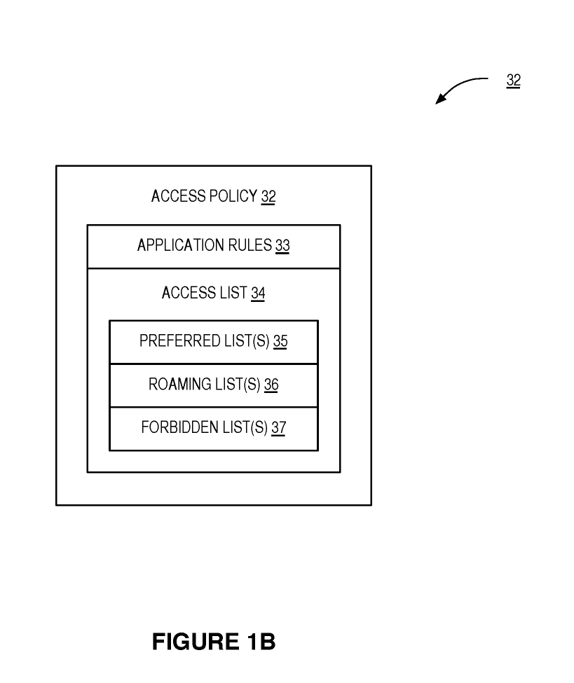

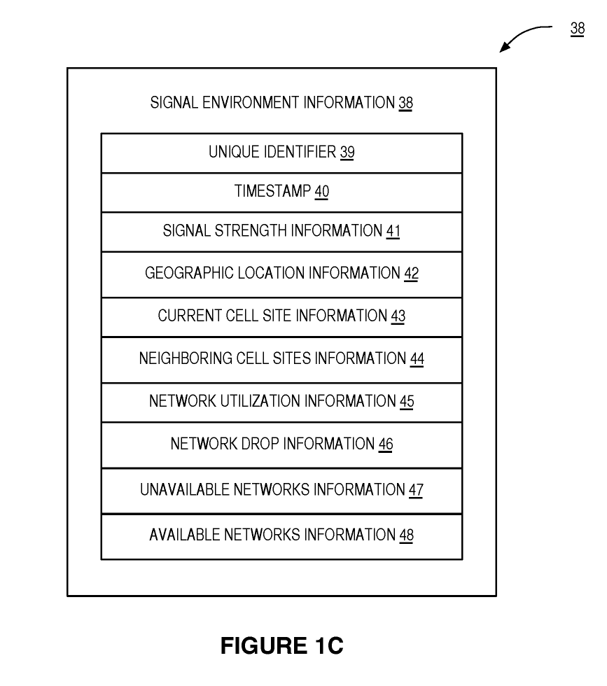

Referring now to FIG. 1A, the system is comprised of a server device 50 and a plurality of remote cellular devices 20, connected through a cellular network 5. The remote cellular device 20 is comprised of a control system 22 and a data store 30. The control system 22 including a communication module 24, survey module 26, and a notification module 28. The data store 30 includes one or more access policies 32 and one or more signal environments 38. The communication module 24 operates to provide network connectivity between the remote cellular device 20 and the server device 50. The survey module 26 operates to collect signal environment information 38. The notification module 28 operates to send and receive notifications to and from the server device 50.

The server device 50 is comprised of a control system 52 and a data store 62. The control system 52 includes an optimization module 54, communication module 56, a statistics module 58, and a notification module 60. The data store 62 is comprised of one or more cellular device records 63, each cellular device record 64 including one or more access policies 32 and one or more signal environments 38. The optimization module 54 operates to determine one or more updated access policies 32. The communication module 56 operates to provide network connectivity between the server device 50 and the remote cellular device 20. The statistics module 58 operates to collect and build a knowledge base of signal environment information 38 based on the information collected from the cellular devices reporting to the server device 50. In some embodiments, the statistics may be organized by geographic location and or cellular device identifier. In some embodiments, the statistics may be stored in a relational database. The notification module 60 operates to send and receive notifications to and from the server device 50. The data store 62 includes one or more access policies 32 and one or more signal environments 38.

The aggregated statistics 66 store information collected from a plurality of the cellular device 20 records in a digested form. The digest includes statistics identifying the best network policy options for particular signal environments. For example, given a geographic location and cellular radio type (as indicated by the unique identifier 39), the aggregated data 66 may be used by the optimization module 54 to make predictions and determine a recommended access policy 32. Over time, as recommended signal policies are determined, applied at the cellular devices 20, and new signal environment information 38 is collected, the aggregated statistics become better through the incorporation of feedback on prediction performance.

Referring now to FIG. 1B the access policy 32 structure stores information including application rules 33 and access list 34 information. The application rules 33 provide the criteria by which the access policy is evaluated for possible application by a cellular device 20. The access list 34 includes a preferred list 35, a roaming list 36, and a forbidden list 37. The preferred list 35 is a list of one or more cellular networks which the cellular device 20 will utilize when available. The roaming list 36 is a list of one or more cellular networks which the cellular device 20 will utilize when a network on the preferred list 35 is not available. The forbidden list 37 is a list of one or more cellular networks which the cellular device 20 is forbidden to utilize.

Application Rules 33 may comprise, for example:
a rule indicating that an updated access policy to be applied when a cellular network signal exceeds a certain threshold
a rule indicating that an updated access policy to be applied when a cellular network signal falls below a certain threshold
a rule indicating that an updated access policy to be applied when network throughput degrades by a certain percentage
a rule indicating that an updated access policy to be applied when network latency degrades by a certain percentage
a rule indicating that an updated access policy to be applied when network drops occur with a greater frequency over a certain time period
a rule indicating that an updated access policy to be applied when a geographic location changes by a certain amount
a rule indicating that an updated access policy to be applied when a certain amount of time elapses
a rule indicating that an updated access policy to be applied when a battery level of the device exceeds a certain level
a rule indicating that an updated access policy to be applied when a battery level of the device falls below a certain level
a rule indicating that an updated access policy to be applied when an amount of data being transferred by the device over a certain time period exceeds a threshold amount
a rule indicating that an updated access policy to be applied when an amount of data being transferred by the device over a certain time period falls below a threshold amount
a rule indicating that an updated access policy to be applied upon receipt
a rule indicating that an updated access policy to be applied at a certain date or time
A rule indicating that an updated access policy to be applied at a certain elevation
a rule indicating that an updated access policy to be applied under certain weather conditions
a rule indicating that an updated access policy to be applied when it is determined that the cellular device has entered a physical structure such as a building
a rule indicating that an updated access policy to be applied when it is determined that the cellular device consumed a certain amount of data on a network
a rule indicating that a user to be prompted for confirmation before applying an updated access policy
a rule indicating that a user to be notified of an updated access policy application
a rule indicating that the server device be notified upon the application of an updated access policy application, and
a rule identifying one or more adjustments to be applied to the one or more application rules based on an emergency mode applied at a cellular device.

Any number of Application Rules 33 may be combined and applied in any order to make a final application determination.

Referring now to FIG. 1C, the signal environment 38 includes a unique identifier 39, a timestamp 40, signal strength information 41, geographic location information 42, current cell site information 43, neighboring cell site information 44, network utilization information 45, and network drop information 46, unavailable networks information 47, newly available networks information 48.

The unique identifier 39 is an identifier uniquely identifying the cellular device. In some embodiments, the unique identifier 39 is one of a ESN, MEID, and a IMEI.

As used herein, a ESN stands for Electronic Serial Number and was/is used in the United States to identify cell phones that require a CDMA network for wireless service. ESNs are slowly being phased out in favor of the MEID, a longer number that is more similar to the IMEI number which is used in GSM and UMTS cell phones.

As used herein, a Mobile Equipment Identifier (MEID) is 14 digits long and is used to identify a cell phone that utilizes the CDMA technology for wireless service. CDMA phones don't typically have SIM cards and CDMA (Code Division Multiple Access) is just a type of technology used for wireless phone service.

As used herein, an International Mobile Station Equipment Identity or IMEI for short is a number that identifies mobile phones that run on a GSM network. GSM is just another type of wireless technology used for mobile service. AT&T and T-Mobile are both wireless carriers that use GSM technology to provide their customers with wireless service. The timestamp 40 stores information identifying the date and time at which the signal environment information 38 was collected. The signal strength information 41 stores information quantifying the signal strength of one or more networks available to the cellular device and present on the access list.

The geographic location information 42 stores information identifying the geographic information at which the signal environment information 38 was collected. In some embodiments, this information is represented as GPS coordinate information. The GPS coordinate information may be collected using a GPS receiver on the cellular device, WIFI triangulation, cell tower information, IP address location information, or any combination thereof. The current cell site information 43 stores information identifying the cellular tower currently providing connectivity to the cellular device. The neighboring cell site information 44 stores information identifying one or more cellular towers adjacent to the current cell tower. The network utilization information 45 stores information indicating the utilization characteristics of one or more of the networks represented on the access list. The network drop information 46 stores information indicating the failure characteristics of one or more of the networks represented on the access list. The unavailable networks information 47 identifies one or more networks that were previously available that are no longer available. In some embodiments, the unavailable networks are networks that were available the last time signal environment information 38 was communicated to the server device 50. The newly available networks information 48 identifies one or more networks that were newly detected by the cellular device. In some embodiments, the available networks are networks that were unavailable the last time signal environment information 38 was communicated to the server device 50.

In some embodiments, network availability is determined by attempting to communicate with one or more test servers using one or more internet protocols and/or applications including but not limited to TCP/IP, UDP, Pinging, and the like. In some embodiments, the test servers may be one or more dedicated servers. In some embodiments, the one or more test servers may be common internet destinations such as google.com, amazon.com, yahoo.com, and the like.

In some embodiments, a cellular device may update its own access list 34 based on the unavailable networks information 47 and/or newly available networks information 48. In some embodiments, the unavailable networks information 47 and/or newly available networks information 48 is sent to the server device 50, and the server device communicates one or more updated access policies 32 to the sending cellular device. In some embodiments, the server may also send updated access policies to other cellular devices in geographic proximity to the sending cellular device. In some embodiments, geographic proximity may be determined physical distance between cellular devices. In some embodiments, geographic proximity may be determined based on the cell cite providing service to the sending cellular device and other cellular devices. Some embodiments may use a combination of the aforementioned methods.

In some embodiments, the unavailable networks information 47 and/or newly available networks information 48 may be tagged with geographical location information and/or time stamp information indicating the location and/or time at which the availability/unavailability determination was made. In some embodiments, this tagging is applied at the cellular device 20. In some embodiments, this tagging takes place at the server device 50.

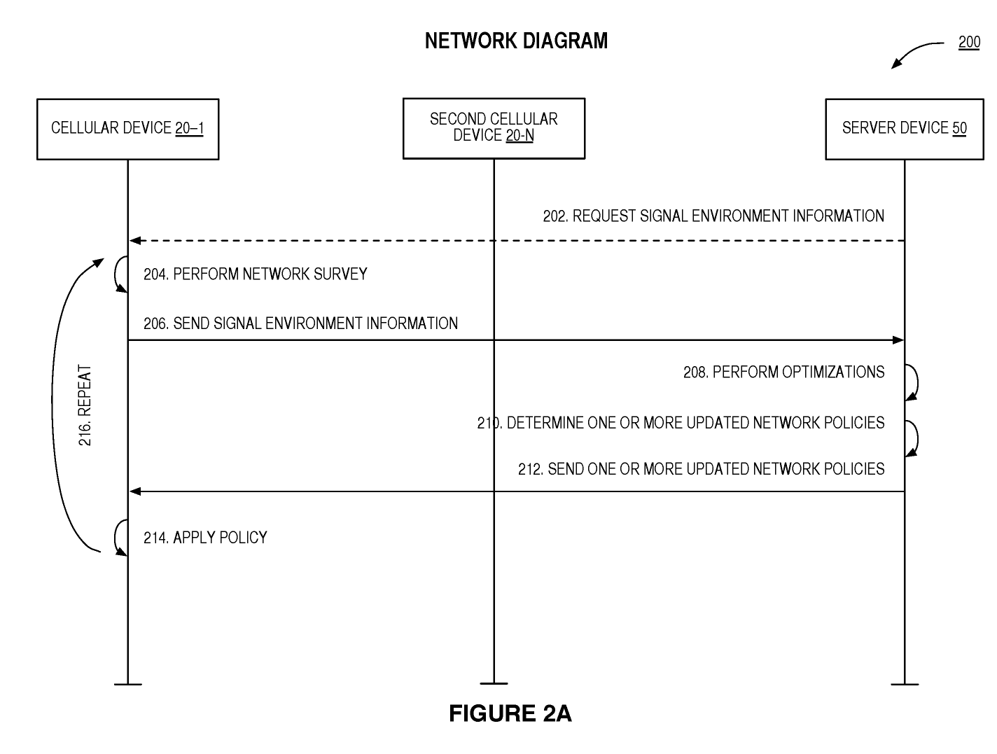

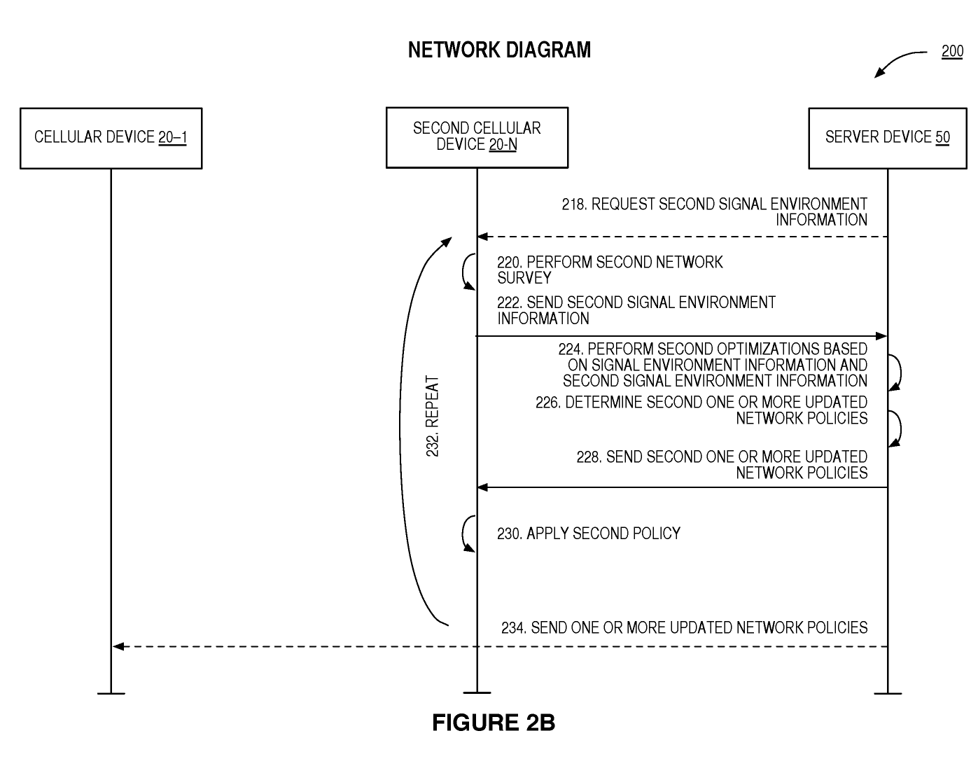

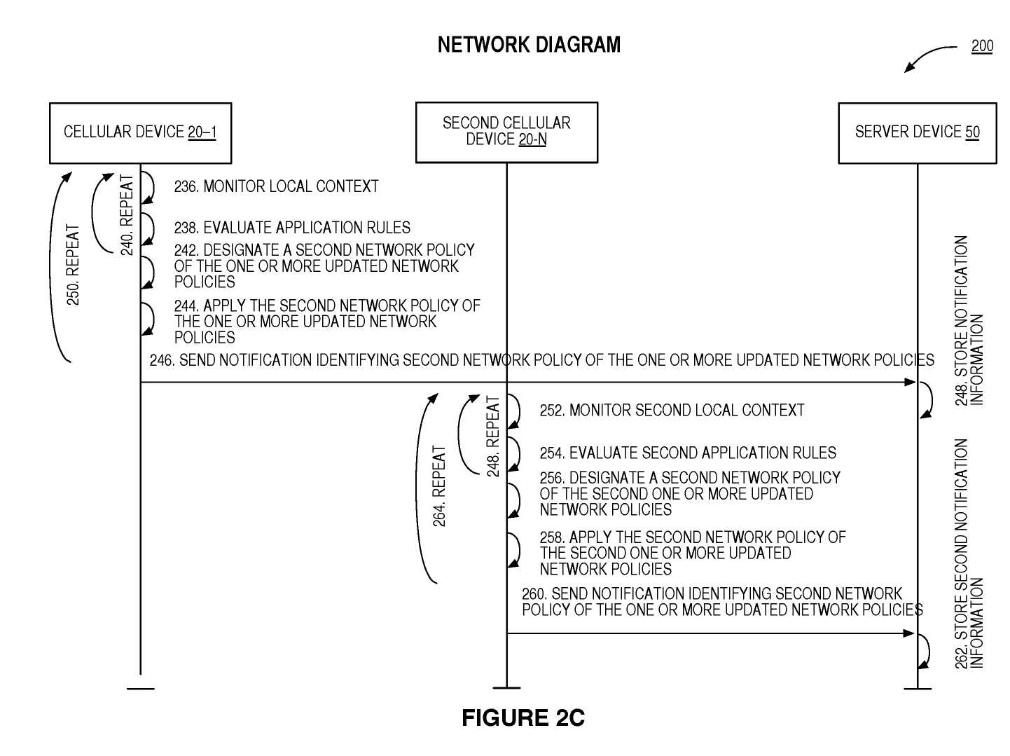

Referring now to FIG. 2A, the server device 50 is coupled to one or more cellular devices, such as remote cellular device 20-1 and second remote cellular device 20-2. In some embodiments, the server device 50 may request 202 signal environment information 38 from the first remote cellular device 20-1. The first remote cellular device 20-1 may perform 204 a network survey to collect the signal environment information 38. The signal environment information 38 may be sent 206 from the first remote cellular device 20-1 to the server device 50. The server device 50 may perform optimizations 208 based on the signal environment information 38 to determine 210 one or more updated network policies 32. The one or more updated network policies 32 may be sent 212 from the server device 50 to the first remote cellular device 20-1. The first remote cellular device 20-1 may apply 214 one of the one or more updated network policies 32. The steps of 202 through 214 may be repeated periodically. In some embodiments, the repeating of the steps may be triggered based on a change in context, wherein the context is determined by geographic location of the cellular device, a time-based trigger, signal strength conditions, current cell tower conditions, neighboring cell tower conditions, network utilization conditions, network drop conditions, or any combination thereof.

Referring now to FIG. 2B, the server device 50 is coupled to one or more cellular devices, such as remote cellular device 20-1 and second remote cellular device 20-2. In some embodiments, the server device 50 may request 218 second signal environment information 38 from the second remote cellular device 20-2. The second remote cellular device 20-2 may perform 220 a second network survey to collect the second signal environment information 38-2. The second signal environment information 38-2 may be sent 222 from the second remote cellular device 20-2 to the server device 50. The server device 50 may perform second optimizations 224 based on the signal environment information 38 and second signal environment information 38-2 to determine 226 second one or more updated network policies 32-2. The second one or more updated network policies 32-2 may be sent 228 from the server device 50 to the second remote cellular device 20-2. The second remote cellular device 20-2 may apply 230 one of the second one or more updated network policies 32-2. The steps of 218 through 234 may be repeated periodically. In some embodiments, the repeating of the steps may be triggered based on a second change in context, wherein the second context is determined by in geographic location of the cellular device, a second time-based trigger, second signal strength conditions, second current cell tower conditions, second neighboring cell tower conditions, second network utilization conditions, second network drop conditions, or any second combination thereof.

Referring now to FIG. 2C, the server device 50 is coupled to one or more cellular devices, such as remote cellular device 20-1 and second remote cellular device 20-2.

The remote cellular device 20-1 may monitor 236 a local context of the remote cellular device 20-1. The context determined by the factors enumerated above. Application rules are evaluated 238 based on the context. The steps of 236 through 238 may be repeated until an evaluation of the application rules indicate that a new network policy should be designated. Based on the outcome of the evaluation, a second network policy 32 may be designated 242. The second network policy 32 may be applied 244 to the remote cellular device 20-1. In some embodiments, a notification is sent 246 from the remote cellular device 20-1 to the server device 50. The steps of 246 through 236 may be repeated on an ongoing basis.

The second remote cellular device 20-2 may monitor 252 a second local context of the second remote cellular device 20-2. The second context determined by the factors enumerated above. Second application rules are evaluated 254 based on the second context. The steps of 252 through 254 may be repeated until a second evaluation of the second application rules indicate that a second new network policy should be designated. Based on the outcome of the second evaluation, a second network policy 32 may be designated 256. The second network policy 32-2 may be applied 258 to the second remote cellular device 20-2. In some embodiments, a second notification is sent 260 from the second remote cellular device 20-2 to the server device 50. The steps of 252 through 260 may be repeated on an ongoing basis.

In some embodiments, the cellular device 20 will receive a plurality of access policies from the server device 50 and make the determination on when a new access policy from the plurality of access policies should be applied. This configuration may desirable because it enables the cellular device 20 to switch to a new access policy when it loses all connectivity and would no longer be able to receive a new policy from the server device 50. This embodiment may also find favor in cellular devices 20 wherein the cellular device 20 has sensing components that allow it to determine its context independently. For example, a cellular phone wherein the cell phone has a GPS receiver and WIFI hardware to enable WIFI location triangulation and may determine its location even when a cellular network 5 is not available.

In some embodiments, the server device 50 will send a single access policy and the cellular device will apply the updated access policy upon receipt.

In some embodiments, the cellular device 20 will automatically, and without additional server device intervention or user interaction, switch back to the previous access list if the updated access policy is determined to represent a lower level of network access policy in comparison to the previous access policy.

In some embodiments, the cellular device 20 will be preconfigured prior to field deployment to perform self-optimization in regards to the access list, and update the access list without ever interaction with the server device 50 in regards to the optimizations. This may occur in instances even when cellular data connectivity is available.

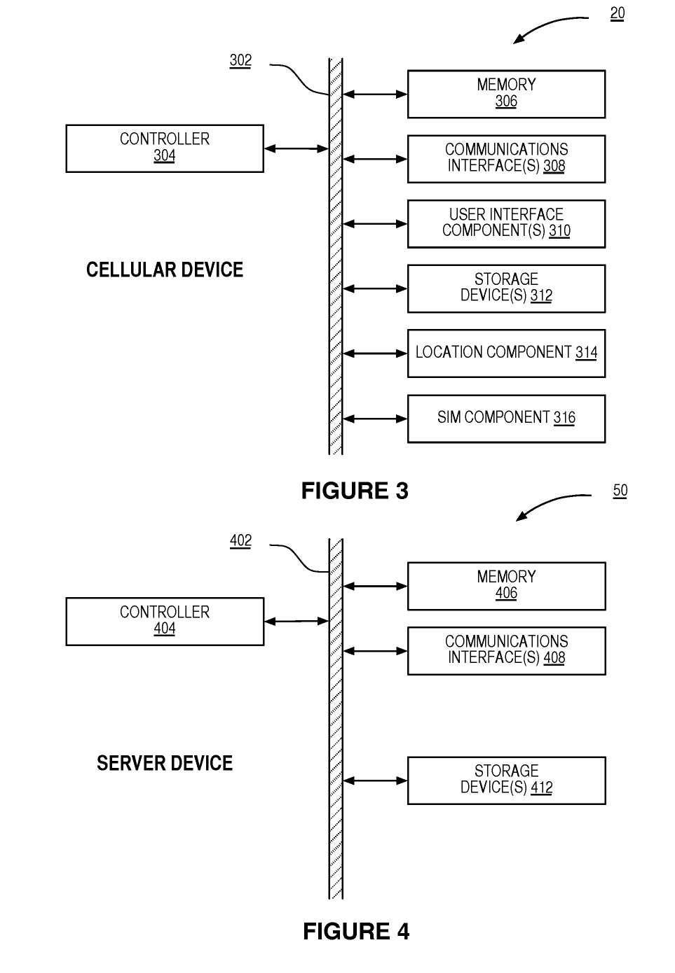

FIG. 3 is a block diagram of a cellular device 20 per one embodiment of the system described herein. As illustrated, the cellular device 20 includes a controller 304 connected to memory 1006, one or more communications interfaces 308, one or more user interface components 310, one or more storage components 312 by a bus 302 or similar mechanism. The controller 304 is a microprocessor, digital ASIC, FPGA, or the like. In general, the cellular device 20 includes a control system 22 having associated memory 306. In this embodiment, the controller 304 is a microprocessor, and the communication module 24 and survey module 26, are implemented in software and stored in the memory 306 for execution by the controller 304. However, the system described herein is not limited thereto. The aforementioned modules may be implemented in software, hardware, or a combination thereof. The cellular device 20 also includes a communication interface 308 enabling the reference cellular device 20 to connect to the cellular network 5. The one or more user interface components 310 include, for example, a touchscreen, a display, one or more user input components (e.g., a keypad), a speaker, or the like, or any combination thereof. The storage component(s) 312 is a non-volatile memory. In some embodiments, the storage device(s) 312 include one or more databases operable to store one or more data items 30 including access policies 32 and signal environments 38.

FIG. 4 is a block diagram of a server device 50 per one embodiment of the system described herein. As illustrated, the server device 50 includes a controller 404 connected to memory 1006, one or more communications interfaces 408, one or more user interface components 410, one or more storage components 412 by a bus 402 or similar mechanism. The controller 404 is a microprocessor, digital ASIC, FPGA, or the like. In general, the server device 50 includes a control system 52 having associated memory 406. In this embodiment, the controller 404 is a microprocessor, and the optimization module 54, communication module 56, statistics module 58, and notification module 60 are implemented in software and stored in the memory 406 for execution by the controller 404. However, the system described herein is not limited thereto. The aforementioned modules may be implemented in software, hardware, or a combination thereof. The server device 50 also includes a communication interface 408 enabling the reference server device 50 to connect to the cellular network 5. The one or more user interface components 410 include, for example, a touchscreen, a display, one or more user input components (e.g., a keypad), a speaker, or the like, or any combination thereof. The storage component(s) 412 is a non-volatile memory. In some embodiments, the storage device(s) 412 include one or more databases operable to store one or more cellular device records 63.

Those skilled in the art will recognize improvements and modifications to the embodiments of the system described herein. All such improvements and modifications are considered within the scope of the concepts disclosed herein and the claims that follow.

What is claimed is:

1. A server device comprising:
a network interface operable to communicate over a network;
a processor and a memory coupled to the network interface and operable to:
receive, from a cellular device, network signal environment information;
determine, based on the network signal environment information, one or more updated access policies; and
send, to the cellular device, the one or more updated access policies.

2. The server device of claim 1 wherein the network signal environment information comprises one or more of:
signal strength information for one or more networks available to the cellular device,
geographic location information for the one or more networks available to the cellular device,
current cell site information for the one or more networks available to the cellular device,
neighboring cell site information for the one or more networks available to the cellular device,
network utilization information for one or more networks available to the cellular device,
unavailable networks information identifying one or more networks previously available to the cellular device having been determined to be unavailable to the cellular device, and
newly available networks information identifying one or more networks previously unavailable to the cellular device and having been determined to be available to the cellular device.

3. The server device of claim 1 wherein the one of the one or more updated access policies comprises one or more of: a preferred policy, roaming policy, and a forbidden policy.

4. The server device of claim 3 further operable to:
receive, from the cellular device, a unique identifier uniquely identifying the cellular device; and
store the network signal environment information by unique identifier, wherein the unique identifier is one or more of a IMEI and a MEID.

5. The server device of claim 1 wherein the server device is further operable to:
receive, from a second cellular device, second network signal environment information;
determine, based on the second network signal environment information, a second updated access policy; and
send, to the second cellular device, the second updated access policy.

6. The server device of claim 1 wherein determining the one or more updated access policies further comprises:
determine, based on the network signal environment information and second network signal environment information, the updated access policy.

7. The server device of claim 1 wherein the server device is further operable to:
determine, based on the network signal environment information, a plurality of updated access policies wherein one or more of the plurality of updated access policies comprises two or more access lists.

8. The server device of claim 1 wherein to send the network signal environment information to the server device, further operable to:
send, at a time designated by the server device, a request for the network signal environment information.

9. The server device of claim 1 wherein ones of the one or more updated access policies comprises one or more access lists, the one or more access lists comprising a preferred list, a roaming list, and a forbidden list configured to instruct the cellular device to:
communicate over a first network specified in the preferred list, when the first network is available;
communicate, over a second network specified in the roaming list, when the first network is unavailable; and
restrict communication, over a third network specified in the forbidden list.

10. The server device of claim 9 wherein each of the one of the one or more updated access policies comprises one or more application rules configured to instruct the cellular device to:
monitor a current context of the cellular device; and
for each of the one or more updated access policies:
perform an evaluation, based on the application rules and the current context, of an applicability score of the one or more updated access policies.

11. The server device of claim 10 wherein the one or more application rules are chosen from the group consisting of:
a rule indicating that an updated access policy to be applied when a cellular network signal exceeds a certain threshold,
a rule indicating that an updated access policy to be applied when a cellular network signal falls below a certain threshold,
a rule indicating that an updated access policy to be applied when network throughput degrades by a certain percentage,
a rule indicating that an updated access policy to be applied when network latency degrades by a certain percentage,
a rule indicating that an updated access policy to be applied when network drops occur with a greater frequency over a certain time period,
a rule indicating that an updated access policy to be applied when a geographic location changes by a certain amount,
a rule indicating that an updated access policy to be applied when a certain amount of time elapses,
a rule indicating that an updated access policy to be applied when a battery level of the device exceeds a certain level,
a rule indicating that an updated access policy to be applied when the battery level of the device falls below a certain level,
a rule indicating that an updated access policy to be applied when an amount of data being transferred by the device over a certain time period exceeds a threshold amount,
a rule indicating that an updated access policy to be applied when an amount of data being transferred by the device over a certain time period falls below a threshold amount,
a rule indicating that an updated access policy to be applied upon receipt,
a rule indicating that an updated access policy to be applied at a certain date or time,
a rule indicating that an updated access policy to be applied at a certain elevation,
a rule indicating that an updated access policy to be applied under certain weather conditions,
a rule indicating that an updated access policy to be applied when it is determined that the cellular device has entered a physical structure such as a building,
a rule indicating that an updated access policy to be applied when it is determined that the cellular device consumed a certain amount of data on a network,
a rule indicating that a user to be prompted for confirmation before applying an updated access policy,
a rule indicating that a user to be notified of an updated access policy application, a rule indicating that the server device be notified upon the application of an updated access policy application, and
a rule identifying one or more adjustments to be applied to the one or more application rules based on an emergency mode applied at a cellular device.

12. A cellular device comprising:
a network interface operable to communicate over a network;
a processor and a memory coupled to the network interface and operable to:
collect network signal environment information;
send the network signal environment information to a server device;
receive, from the server device, one or more updated access policies; and
apply one of the one or more updated access policies.

13. The cellular device of claim 12 wherein the network signal environment information comprises one or more of:
signal strength information for one or more networks available to the cellular device,
geographic location information for the one or more networks available to the cellular device,
current cell site information for the one or more networks available to the cellular device,
neighboring cell site information for the one or more networks available to the cellular device,
network utilization information for one or more networks available to the cellular device,
unavailable networks information identifying one or more networks previously available to the cellular device having been determined to be unavailable to the cellular device, and
newly available networks information identifying one or more networks previously unavailable to the cellular device having been determined to be available to the cellular device.

14. The cellular device of claim 12 wherein the one of the one or more updated access policies comprises one or more of: a preferred policy, roaming policy, and a forbidden policy.

15. The cellular device of claim 12 wherein determining one or more updated access policies further comprises:
determine, based on the network signal environment information and second network signal environment information, the updated access policy.

16. The cellular device of claim 12 wherein the cellular device is further operable to:
determine current operating conditions;
designate, based on the current operating conditions, another of the one or more updated access policies; and
apply the other of the one or more updated access policies.

17. The cellular device of claim 12 wherein sending the network signal environment information to the cellular device further operable to:
send, at a time designated by the cellular device, the network signal environment information to the server device.

18. The cellular device of claim 12 wherein sending the network signal environment information to the cellular device further operable to:
receive, from the server device, a request for the network signal environment information; and
send, based on the request, the network signal environment information to the server device.

19. The cellular device of claim 12 wherein ones of the one or more updated access policies comprise one or more access lists, the one or more access lists comprising the one or more access lists include a preferred list, a roaming list, and a forbidden list configured to instruct the cellular device to:
communicate over a first network specified in the preferred list, when the first network is available;
communicate, over a second network specified in the roaming list, when the first network is unavailable; and
restrict communication, over a third network specified in the forbidden list.

20. The cellular device of claim 19 wherein ones of the one of the one or more updated access policies comprises one or more application rules configured to instruct the cellular device to:
monitor a current context of the cellular device; and
for each of the one or more updated access policies:
perform an evaluation, based on the application rules and the current context, of an applicability score of the one or more updated access policies;
based on the evaluation, designate a new updated access policy;
apply the new updated access policy; and
send, to the server device, a notification identifying the new updated access policy.

21. The cellular device of claim 20 wherein the one or more application rules are chosen from the group consisting of:
a rule indicating that an updated access policy to be applied when a cellular network signal exceeds a certain threshold,
a rule indicating that an updated access policy to be applied when a cellular network signal falls below a certain threshold,
a rule indicating that an updated access policy to be applied when network throughput degrades by a certain percentage,
a rule indicating that an updated access policy to be applied when network latency degrades by a certain percentage,
a rule indicating that an updated access policy to be applied when network drops occur with a greater frequency over a certain time period,
a rule indicating that an updated access policy to be applied when a geographic location changes by a certain amount,
a rule indicating that an updated access policy to be applied when a certain amount of time elapses,
a rule indicating that an updated access policy to be applied when a battery level of the device exceeds a certain level,
a rule indicating that an updated access policy to be applied when the battery level of the device falls below a certain level,
a rule indicating that an updated access policy to be applied when an amount of data being transferred by the device over a certain time period exceeds a threshold amount,
a rule indicating that an updated access policy to be applied when an amount of data being transferred by the device over a certain time period falls below a threshold amount,
a rule indicating that an updated access policy to be applied upon receipt,
a rule indicating that an updated access policy to be applied at a certain date or time,
a rule indicating that an updated access policy to be applied at a certain elevation,
a rule indicating that an updated access policy to be applied under certain weather conditions,
a rule indicating that an updated access policy to be applied when it is determined that the cellular device has entered a physical structure such as a building,
a rule indicating that an updated access policy to be applied when it is determined that the cellular device consumed a certain amount of data on a network,
a rule indicating that a user to be prompted for confirmation before applying an updated access policy,
a rule indicating that a user to be notified of an updated access policy application,
a rule indicating that the server device be notified upon the application of an updated access policy application, and
a rule identifying one or more adjustments to be applied to the one or more application rules based on an emergency mode applied at a cellular device.

22. A system comprising:
a server device comprising:
a first network interface operable to communicate over a network;
a first processor and a first memory coupled to the first network interface and operable to:
receive, from a cellular device, network signal environment information;
determine, based on the network signal environment information, one or more updated access policies;
send, to the cellular device, the one or more updated access policies; and
the cellular device comprising:
a second network interface operable to communicate over the network;
a second processor and a second memory coupled to the second network interface and operable to:
collect network signal environment information;
send the network signal environment information to the server device;
receive, from the server device, the one or more updated access policies; and
apply one of the one or more updated access policies.
